(19) United States
(12) Patent Application Publication
(10) Pub. No.: US 2006/0184296 A1
(43) Pub. Date: Aug. 17, 2006

(54) Machine vision vehicle wheel alignment systems

(75) Inventors: David A. Voeller, St. Louis, MO (US); John Kenneth Korte, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Hunter Engineering Company

(21) Appl. No.: 11/357,498

(22) Filed: Feb. 17, 2006

Related U.S. Application Data
(60) Provisional application No. 60/654,011, filed on Feb. 17, 2005.

(51) Int. Cl. G06F 19/00

(52) U.S. Cl. 701/33; 701/29

(57) ABSTRACT

A machine vision vehicle service system including a console unit, optical sensors, and optional optical targets for disposition within fields of view of the optical sensors. The console unit contains a central processing unit configured with multiple processing cores and which is configured with image processing and vehicle service software applications adapted for execution on the multi-core processor. The console further incorporates various operator interfaces, including a keyboard, a mouse, a printer, and a display device. The optical sensors are coupled to the computer, and are aligned with fields of view which may encompass the wheels or components of a vehicle undergoing an alignment inspection.

### CROSS-REFERENCE TO RELATED APPLICATIONS

The present application is related to, and claims priority from, U.S. Provisional Patent Application No. 60/654,011 filed on Feb. 17, 2005, which is hereby incorporated by reference.

### STATEMENT REGARDING FEDERALLY SPONSORED RESEARCH

Not Applicable.

### BACKGROUND OF THE INVENTION

The present invention relates generally to machine vision vehicle wheel alignment systems configured to measure the location and orientation of the wheels of a vehicle in a three dimensional coordinate system, and more particularly, to embodiments of machine vision vehicle wheel alignment systems configured to utilize multi-core central processing units, as well as high-speed communication buses to interconnect the central processing units with peripheral components.

Machine vision vehicle wheel alignment systems have been in use by the vehicle service industry for several years. A typical machine vision vehicle wheel alignment system, such as the Series 811 wheel alignment system, configured with the DSP600 sensors manufactured by Hunter Engineering Co. of Bridgeton, Mo., consists of a console unit, optical sensors such as cameras, and optical targets. The console unit contains a central processing unit (CPU), such as a digital signal processor, microprocessor, or other logic circuit, configured with image processing and vehicle wheel alignment software applications, and incorporates various operator interfaces, including a keyboard, a mouse, a printer, and a display device. The optical sensors are coupled to the central processing unit either directly or indirectly, and the optical targets are disposed in the field of view of the optical sensors, typically mounted to the wheels or components of a vehicle undergoing an alignment inspection.

Commonly, to view the left and right sides of a vehicle, at least one optical sensor is disposed on each side of the vehicle having a field of view encompassing one or more wheels of the vehicle. In alternative configurations, two optical sensors are provided on each side of the vehicle, each having a field of view encompassing a single vehicle wheel, i.e. a left front, left rear, right front, and right rear wheel, respectively. To facilitate vehicle wheel alignment, optical targets are mounted on the vehicle wheels, and observed by the optical sensors. The optical targets preferably have a set of predetermined features which are identified in images obtained by the optical sensors, and which facilitate a determination of the position and orientation of the optical targets. Processing of the acquired images of the optical targets may be carried out by dedicated processing circuits associated with the optical sensor modules, in an interface computer, or in the console computer system. Similar procedures may be utilized to determine a position and/or orientation of a vehicle body component, vehicle support structure, or other item within the field of view of the optical sensors.

Once the position and orientation of each optical target is determined, the position and orientation of the associated vehicle wheel, vehicle body component, or object can be determined, and correspondingly, the various vehicle wheel alignment angle measurements may be either determined or calculated. These angles typically include camber, caster, and toe angles for each vehicle wheel, the vehicle centerline, and the vehicle rear thrust line. For vehicle body components, the measured characteristics may include vehicle ride height, vehicle guidance system alignment, or vehicle component alignment.

Advanced alignment procedures require more information to be extracted from images acquired by optical sensor modules. Hence, the acquired image data from the optical sensors in a machine vision vehicle wheel alignment system includes increasingly large amounts of data. Higher image resolution for increased alignment angle accuracy, faster image acquisition speeds for the detection of movement by vehicle components, and an increased number of optical sensors for measurement of both vehicle components and wheel alignment angles, often while a vehicle is in motion, place an increased demand for processing capacity on a vehicle wheel alignment system.

Improved processor architectures and associated specialized software applications have been developed to meet the needs of a few limited markets, such as graphics intensive gaming applications, military applications, and virtual modeling of weather patterns, ocean currents, etc. To utilize these improved processor architectures, the associated software applications must be specifically designed to take advantage of the specific features provided. Additionally, device drivers for interfacing with various components of the system must be adapted to allow for the sharing of resources which occurs in a multi-core or multi-threaded system.

Accordingly, as there is a clear need for an increase in processing capability in machine vision vehicle wheel alignment systems, and particularly for an increase in image processing capability, it would be advantageous to provide a machine vision vehicle wheel alignment system with improvements in processor architecture and functionality which would enable the system to concurrently process software applications having multiple streams of data or instructions, such as from individual optical sensors. It would further be advantageous to provide increased data transfer capacity between various components of the machine vision vehicle wheel alignment system such as individual optical sensors and the system processor.

### BRIEF SUMMARY OF THE INVENTION

Briefly stated, an embodiment of the present invention provides a machine vision vehicle wheel alignment system including a console unit, optical sensors such as cameras, and optional optical targets for disposition within fields of view of the optical sensors. The console unit contains a central processing unit or computer configured with multiple processing cores, such as a digital signal processor, microprocessor, or other logic circuit, configured with suitable image processing and vehicle wheel alignment software applications adapted for concurrent execution of multiple instruction threads. The console further incorporates various operator interfaces, including a keyboard, a mouse, a printer, and a display device. The optical sensors are coupled to the computer, and are aligned with fields of view which may encompass the wheels or components of a vehicle undergoing an alignment inspection.

In an alternate embodiment of the machine vision wheel alignment system of the present invention, the central processor is configured to utilize Hyper-Thread technology to provide enhanced processing capacity by enabling concurrent processing of multiple application threads on a single processing core within the computer.

In an alternate embodiment of the machine vision wheel alignment system of the present invention, the central processor is configured to utilize Virtualization Technology (VT), also known as “Vanderpool” technology, to provide enhanced processing capacity by enabling the central processor to function as several individual processors working in parallel.

In an alternate embodiment of the machine vision wheel alignment system of the present invention, the computer is configured with at least one CELL-based central processor, including at least one CELL processing element. The CELL-based processor is capable of utilizing multiple interconnected CELL processing elements, as required to carry out wheel alignment procedures. The CELL processing elements may be directly associated with the CELL-based central processor of the machine vision wheel alignment system, or may be associated with a CELL-based processor in communication therewith via a communications network to facilitate distributed processing.

In an alternate embodiment of the machine vision vehicle wheel alignment system of the present invention, the central processor is configured with a PCI Express communication bus between one or more peripheral components and the a processing core.

In an alternate embodiment of the machine vision wheel alignment system of the present invention, the central processor incorporates an improved communication bus which consists of an assembly of serial, point-to-point wired, individually clocked data pathways each consisting of two pairs of data lines carrying bidirectional data.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a block diagram illustrating the components of a machine vision vehicle wheel alignment system of the present invention configured with a multi-core central processing unit;

FIG. 2 is a block diagram illustrating the components of a machine vision vehicle wheel alignment system of the present invention configured with a hyper-threaded central processing unit;

FIG. 3 is a comparison of a prior art dual processor system with a prior art processor supporting hyper-threading technology;

FIG. 4 illustrates prior art Intel NetBurst™ hardware micro architecture duplicated and shared resources for a computer processor configured to support Hyper-Threading technology;

FIG. 5 is a block diagram illustrating the components of a machine vision vehicle wheel alignment system of the present invention incorporating a Vanderpool or VT configured central processing unit;

FIG. 6 is a block diagram illustrating the components of a machine vision vehicle wheel alignment system of the present invention configured with a CELL processor unit;

FIG. 7 is a block diagram illustrating the components of a machine vision vehicle wheel alignment system of the present invention configured with a PCI Express bus coupled between peripheral components and a central processing unit;

FIG. 8 is an illustration of the prior art PCI Express bus layered architecture;

FIG. 9 is an expanded illustration of the transaction layer, data link layer, and physical layer of the prior art PCI Express bus architecture shown in FIG. 8;

FIG. 10 is a physical link diagram of the prior art a PCI Express bus shown in FIG. 8; and

FIG. 11 is a block diagram illustrating the components of a machine vision vehicle wheel alignment system of the present invention configured with an improved video bus coupled between the imaging components and the central processing unit.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

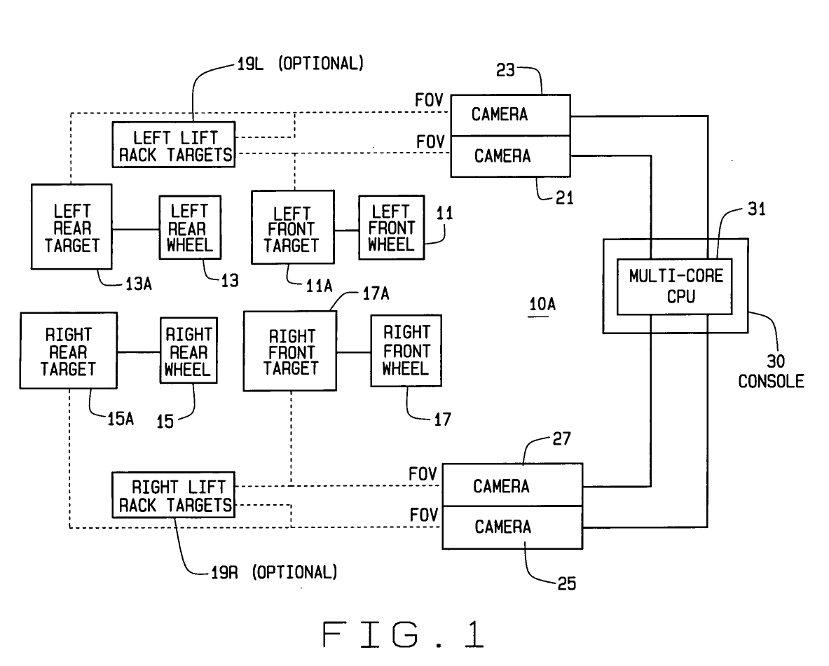

Turning to FIG. 1, a vehicle wheel alignment system 10A of the present invention is shown incorporating the basic peripheral components of a conventional machine vision vehicle wheel alignment system, such as the Series 811 Aligner with the DSP600 sensors from Hunter Engineering Co. of Bridgeton, Mo. The vehicle wheel alignment system 10A is configured to determine the position and orientation of vehicle wheels 11, 13, 15, and 17, and the axis about which they roll. Each vehicle wheel may have associated therewith one or more optical targets 11A, 13A, 15A, and 17A. Optionally, additional optical targets, such as 19L and 19R, may be associated with vehicle components, the two sides of a runway, or other support structure on which the vehicle wheels rest. The optical targets such as 19L and 19R associated with the runways on which the vehicle wheels 11, 13, 15, and 17 rest may be used during the measurement process to define and measure the location, in a coordinate reference system, of the common plane of the runways, as described in U.S. Pat. No. 5,724,128 to January.

The images of the optical targets, or the vehicle wheel themselves, are preferably obtained by four optical sensors 21, 23, 25, and 27, with one optical target associated with each wheel. The optical paths (fields of view) between the targets and the corresponding optical sensors are illustrated by the dashed lines in FIG. 1. Those of ordinary skill in the art will recognize that the number of optical sensors may be varied, provided that images of each optical target are obtained and processed by the vehicle wheel alignment system 10A. Each optical sensor 21, 23, 25, and 27 provides a stream of image data to the vehicle wheel alignment system central processor for subsequent processing.

Alternate configurations of machine vision vehicle wheel alignment systems do not require an optical target to be mounted to the vehicle wheels, or may be configured to detect defective vehicle components by acquiring multiple images through at least some of the optical sensors during a steering procedure. These configurations of machine vision vehicle wheel alignments systems require increased image processing capacity to processes the increased number of acquired images.

A processing system architecture which is designed to process more than one software thread execution simultaneously may be adapted for use in a machine vision vehicle wheel alignment system if suitable changes are made in the associated vehicle wheel alignment software applications. In one embodiment of the present invention, a multi-core processor and associated system BIOS and device drivers, are configured to process an increased number of instructions per clock cycle, and handle more than one thread execution simultaneously, to provide improved performance in a machine vision vehicle wheel alignment system having an alignment software application adapted for multi-threaded execution. The multi-core processor is configured to execute alignment software instructions utilizing multiple processing threads which, for example, may include individual processing threads associated with image data obtained from each optical sensor in the machine vision vehicle wheel alignment system.

Multi-core processors may include two or more processing cores, each of which is configured for concurrent and independent processing of software threads, instructions, or data streams. In an embodiment of the present invention shown in FIG. 1, the vehicle service system 10A is configured with a multi-core central processing unit (CPU) 31 or computer disposed with the console to receive and process the software instructions designed in part to process the image data signal streams associated with acquired images from each of the optical sensors.

The multi-core CPU 31 is configured with at least one vehicle service software application adapted for execution on the multi-core CPU 31, to utilize data from the acquired images to determine various wheel alignment angles, vehicle properties, or vehicle support references. For example, a vehicle wheel alignment software application may allocate a process thread for each optical sensor 21, 23, 25, and 27, such that each process thread is responsible for acquiring and processing image data signals. Within the multi-core CPU 31, every process thread has a thread priority such that a thread of a higher thread priority receives more CPU time than a thread of a lower priority. For example, a GUI thread (Graphical User Interface) may be configured with a higher priority than an image processing thread from one of the optical sensors. When the user is pressing softkeys, drop down menus, buttons, icons, etc., the GUI response is not slowed down by the image processing threads, and appears responsive to an operator's input. In contrast, when the GUI is displaying a generally static graphical display which is occasionally updated with current alignment values, the image processing threads may receive the majority of the CPU 31 capacity because of the GUI thread's inactivity. In a machine vision wheel alignment system such as 10A configured with a multi-core CPU 31, the work being done by each logical processing block of the physical processor for the aligner process is automatically divided. The vehicle wheel alignment software can be further enhanced by assigning a thread affinity for each thread to a particular logical processing block, i.e. for a machine vision vehicle wheel alignment system having four optical sensors, assigning image processing threads associated with each optical sensor to a corresponding logical processing block or core within the multi-core CPU 31.

The procedures for calculating alignment angles, properties, and references from the acquired images of the optical targets are well known, and may be done in a variety of ways, such as shown in U.S. Pat. Nos. 5,488,472, 5,870,315, 5,675,515, and 5,724,128, the disclosures of which are herein incorporated by reference. Correspondingly, methods and procedures for processing images acquired by the optical sensors 21, 23, 25, and 27 to establish coordinate reference systems, identify positions and orientations within those established coordinate reference systems, transform data between established coordinate reference systems, and to determine vehicle measurements, are well known to those of ordinary skill in the art of machine vision vehicle wheel alignment, and are shown in U.S. Pat. No. 6,064,750 to January et al., and U.S. Pat. No. 6,134,792 to January, the disclosures of which are herein incorporated by reference.

Optionally, the multi-core processor 31 in the vehicle wheel alignment system 10A may be configured with available Active Management Technology features to enable remote control of the multi-core processor 31. For example, if a vehicle wheel alignment system connected to a network of other computer systems, such as the Internet, is distributing viruses, Active Management Technology enables an authorized user, via a remote system, to gain control of the infected multi-core processor 31 to take corrective action. Active Management Technology further enables an authorized user to access and inventory the vehicle wheel alignment system when the system is powered off.

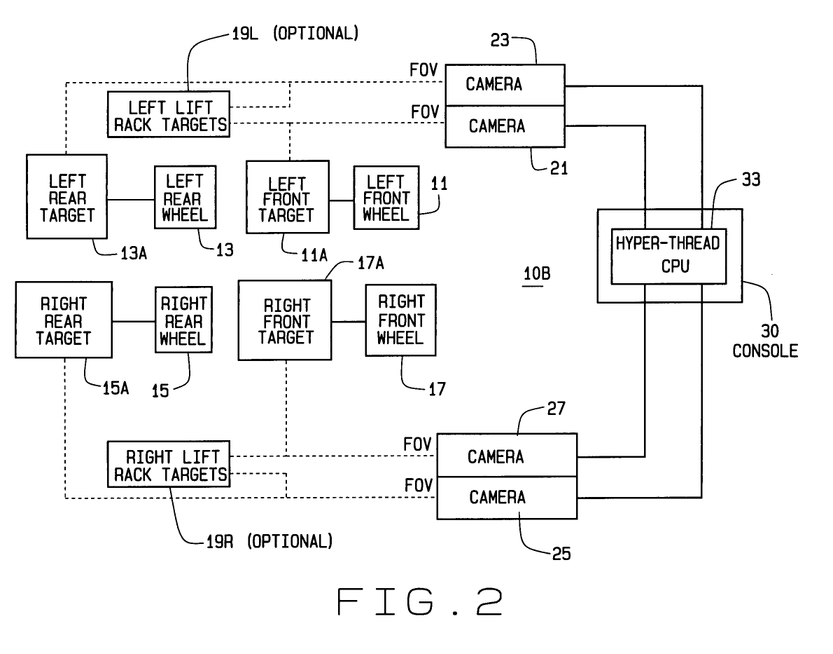

In an alternate embodiment of the present invention, shown in FIG. 2, a vehicle wheel alignment system 10B utilizing single-core processor 33 is configured to utilize a multi-processing technology, known as Hyper-Threading. By incorporating a Hyper-Threading configured single-core processor 33, the vehicle wheel alignment system 10B is capable of carrying out two actions at once, similar to the operation of the vehicle wheel alignment system 10A with the multi-core processor 31. Using Hyper-Threading, the single physical processor 33 is configured to execute two separate code streams (called threads) concurrently, increasing processor utilization and providing greater throughput and improved performance.

For example, the vehicle wheel alignment system 10B may be used to acquire as much image data as possible during a steering procedure and to subsequently process the image data when the steering procedure is completed. When the steering procedure is started, image processing threads for the left front optical sensor 21 and left rear optical sensor 23 may be assigned to a first logical processing block (ProcA) of the processor 33. The image processing threads for the right front optical sensor 27 and right rear optical sensor 25 may be assigned to a second logical processing block (ProcB) of the processor 33. The threads for the left rear optical sensor 23 and right rear optical sensor 25 acquire and process images at a relatively slow rate, i.e., with an update at a rate of once every two seconds. Optionally, the rate may be set by the number of times the threads for the front optical sensors update (i.e. one rear update for every 10 front updates) or in some increment of front steering (i.e. one rear update for every two degrees of steer). The rear optical sensor update rate is preferably selected to provide sufficient time to update overall alignment readings based on rear axle alignment readings that are not moving or moving very little during the steering procedure.

In contrast, the image processing threads for the left front optical sensor 21 and right front optical sensor 27 are configured to acquire images of the steering wheels as rapidly as possible. However, not all of the acquired images are immediately processed. Preferably, only a fraction of the acquired steered wheel images are processed to estimate the vehicle's steering position and the associated steered wheel alignment readings during the steering procedure. All of the images being captured may be stored for later processing as system resources become available. Optionally, metadata may be stored together with the image data to identify an image sequence number, a time of capture, an approximate steered location, etc. The determination of when to process the image captured by a particular thread can be related to time (i.e. 1/500 ms), number of images (i.e. one image processed for every five images captured) or a combination of the two (i.e. one image every 500 ms unless there were more than five images captured in which case it is one image for every five images). The determination rate does not have to be constant. As the physical location of the steered wheels approaches a target steered orientation, the rate of image processing may increase.

When the steering procedure is completed, the processing of remaining stored image data may be carried out by the processor 33 executing multiple processing threads. To detect defective vehicle components, images may be processed to identify observable changes in alignment values which have known relationships to various vehicle components. For example, camber and toe alignment angles for a selected steered wheel may be processed to determine a line fitting algorithm, and discontinuities in the alignment data identified. The actual acquired alignment data may be compared with the curve defined by the determined line fitting algorithm to identify points exceeding a difference threshold. Alternatively each unit of data may be compared with a moving average to identify differences beyond a threshold. If a discontinuity is found, a warning may be provided identifying a possible worn vehicle component in the steering and suspension system of the vehicle. Optionally, the steered location of the discontinuity is identified, and an operator is directed to return the steered vehicle wheel to the identified location. The direction in which the discontinuity was detected is also known, and the procedure can have the operator steer the vehicle passed the point of discontinuity while observing the steering and suspension components for a bad part.

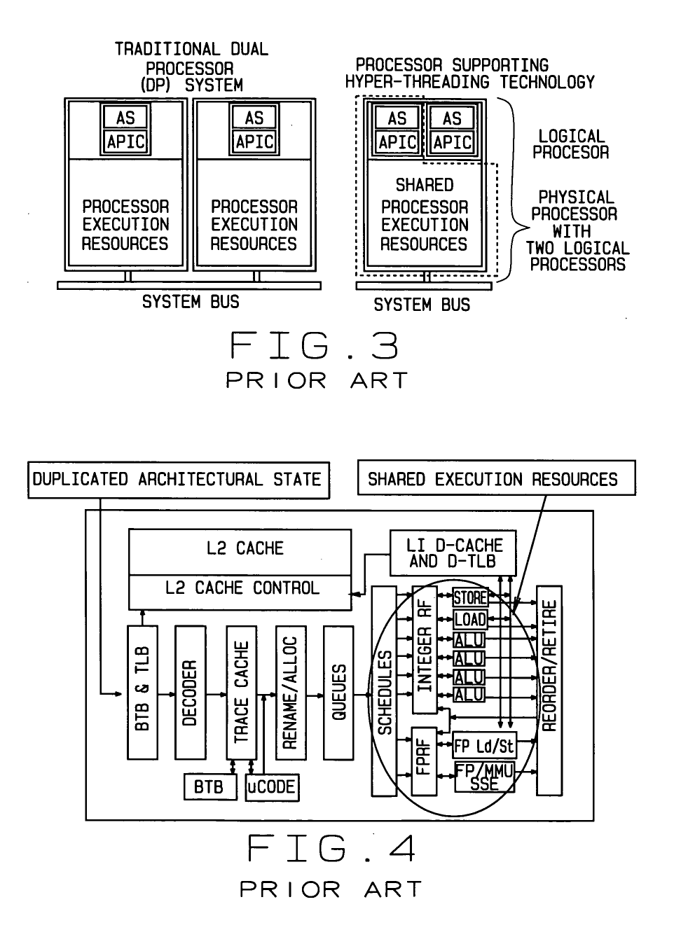

Architecturally, the processor design in a vehicle wheel alignment system 10B supporting Hyper-Threading Technology consists of two logical processors as shown in FIG. 3, each of which has its own architectural state. The architectural state that is duplicated for each logical processor consists of the data registers, segment registers, control registers, debug registers, and most of the Model Specific Registers (MSRs). Each logical processor also includes a dedicated Advanced Programmable Interrupt Controller (APIC). After power-up and initialization, each logical processor can be individually halted, interrupted, or directed to execute a specified thread, independently from the other logical processor on the single processor core in the vehicle service system.

Unlike multi-processor configurations which require two separate physical processors as shown in FIG. 3, the logical processors in the single-core processor 33 of the vehicle wheel alignment system 10B configured with Hyper-Threading technology, share the execution resources of the processor core as shown in FIG. 4. The shared execution resources include the execution engine, caches, system bus interface, and the firmware. The Hyper-Threading technology improves the performance of the single-core processor 33 in the vehicle wheel alignment system 10B by maximizing the use of available execution resources in the system architecture, and exploiting the multi-threaded nature of contemporary operating systems, such as Microsoft Windows XP, which are preferably utilized with the vehicle wheel alignment system 10B.

Most contemporary operating systems, including Microsoft Windows XP and certain versions of Linux, divide their workload into processes and threads that can be independently scheduled and dispatched to run on two or more processors. The same division of workload can applied to a multi-threaded vehicle wheel alignment application. Hyper-Threading technology leverages the process- and thread-level parallelism found in contemporary operating systems and multi-threaded wheel alignment applications by allowing threads to be executed on separate logical processors. Instructions from both threads are simultaneously dispatched for execution by the single processor 33 using out-of-order instruction scheduling to keep as many execution units as possible busy during each processor clock cycle.

A vehicle wheel alignment system 10B single-core processor 33 supporting Hyper-Threading Technology utilizes available execution units in the processor 33 more frequently than a traditional single-core processor, reducing idle time on the processor 33. For example, by configuring a multi-threaded vehicle wheel alignment software application in such a way that different threads can use different resources in parallel (i.e., scheduling integer computation-intensive work on one logical processor while running floating-point computations on the other), then throughput for the single-core processor 33 increases significantly. Vehicle wheel alignment systems 10B incorporating single-core processors 33 supporting Hyper-Threading technology increase instruction processing throughput and can take advantage of otherwise idle processor resources, which improve performance on both multi-threaded vehicle service applications and multi-tasking environments.

For example, as shown in FIG. 2, the acquired image signals from the optical sensors 21, 23, 25, and 27 of a machine vision vehicle wheel alignment system 10B are supplied to the wheel alignment system console 30, to a Hyper-Threading central processing unit 33. During a vehicle wheel alignment compensation procedure, the vehicle and associated optical targets are rolled while the optical sensors 2, 23, 25, and 27 track the movement of the wheels. Tracking the movement requires calculation of a cross product between the tracked objects or targets in two subsequent images. This cross product calculation is best done when there is little spatial separation between the features in the acquired images, necessitating either slow rolling movement of the vehicle or a high image acquisition rate by the optical sensors. Since there are multiple vehicle wheels which are to be tracked during a rolling compensation procedure, several image streams must be processed. If there are two optical sensors employed (one for each side of the vehicle) then there are two streams of acquired images. If four optical sensors are employed (one for each wheel) there are four streams of acquired images. Machine vision wheel alignment systems employing stereo imaging will require eight image streams. To maintain the required tolerances, the images for an individual wheel are preferably spatially close, which necessitates that only a fraction of the images captured are processed during the actual compensation procedure to identify the relative distance over which the vehicle has been rolled.

Once the compensation procedure is completed, all of the captured images are processed to accurately identify selected compensation vectors. If predefined objects of a known geometry, such as reflective stickers are used as the objects being tracked instead of random features, increased accuracy may be obtained by adding additional objects (more stickers). As more objects are added (more unknowns), an increased number of images must to be processed to identify the selected compensation vectors.

Preferably, when the compensation procedure is initiated, a software thread for each optical sensor 21, 23, 25, and 27 is initiated and assigned a processor affinity to an available logical processing block in the CPU. Images are captured and stored for all image threads as the vehicle is rolled. Optionally, metadata may be stored together with the image data to identify an image sequence number, a time of capture, an approximate steered location, etc. A fraction of the captured and stored images are processed to determine how far the vehicle has rolled. The processing rate may be based on a metric such as elapsed time or the number of images acquired. The processing rate may dynamically change during the procedure to increase as the vehicle nears a selected target stopping location.

Once the rolling compensation procedure is completed, all of the stored images may be processed to accurately identify a compensation vector for use with subsequent alignment angle measurements. The alignment readings initially displayed may have a reduced accuracy until the image processing for all the images has been completed, at which time the displayed measurements may be dynamically updated. By splitting the image processing calculations between different threads, a multi-core and/or Hyper-Threaded CPU may process each thread within a different logical processor block concurrently to obtain the desired results in a user responsive manner.

An alternative technology to hyper-threading, which may be utilized to virtualize multiple processors within a single-core processor, is commonly referred to in the industry as Virtualization Technology (VT) or “Vanderpool” technology. A VT configured processor is enabled to carry out multiple functions by simultaneously providing multiple partitions, each of which can have a different function, and allows more than one operating system to be run on a single processor. Using VT enables more than one vehicle service product to run at the same time on the same processor. For example, one partition may scan for software viruses, while a second partition execution a vehicle wheel alignment software application.

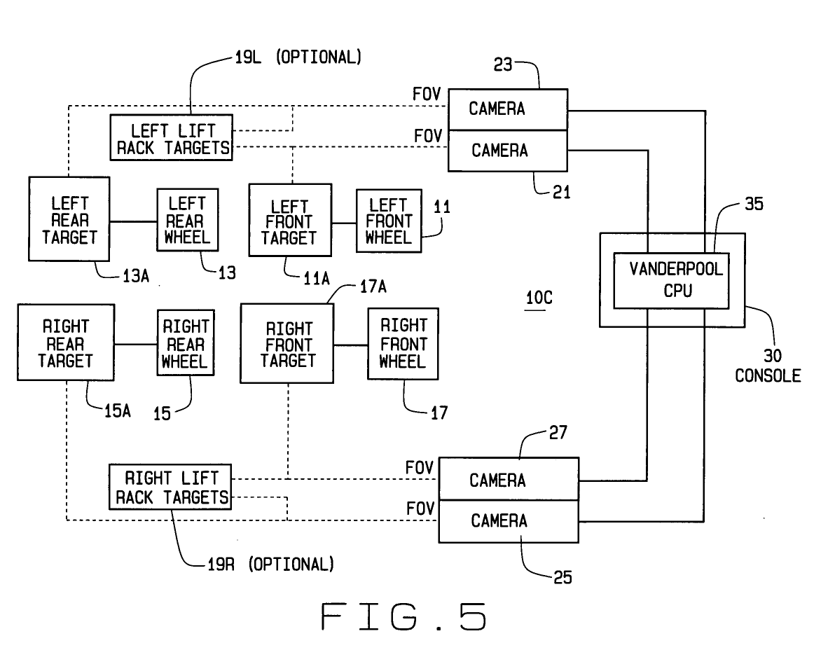

In an alternate embodiment for vehicle wheel alignment system 10C of the present invention, shown in FIG. 5, the acquired image signals from the optical sensors 21, 23, 25, and 27 are supplied to a VT configured central processing processor 35. The VT central processing processor 35 is configured with vehicle wheel alignment software adapted for execution on a VT-type processor to utilize the acquire image signal data to determine various wheel alignment angles and carry out vehicle wheel alignment service procedures with improved efficiency over a conventional machine vision vehicle wheel alignment system using a single core central processing unit.

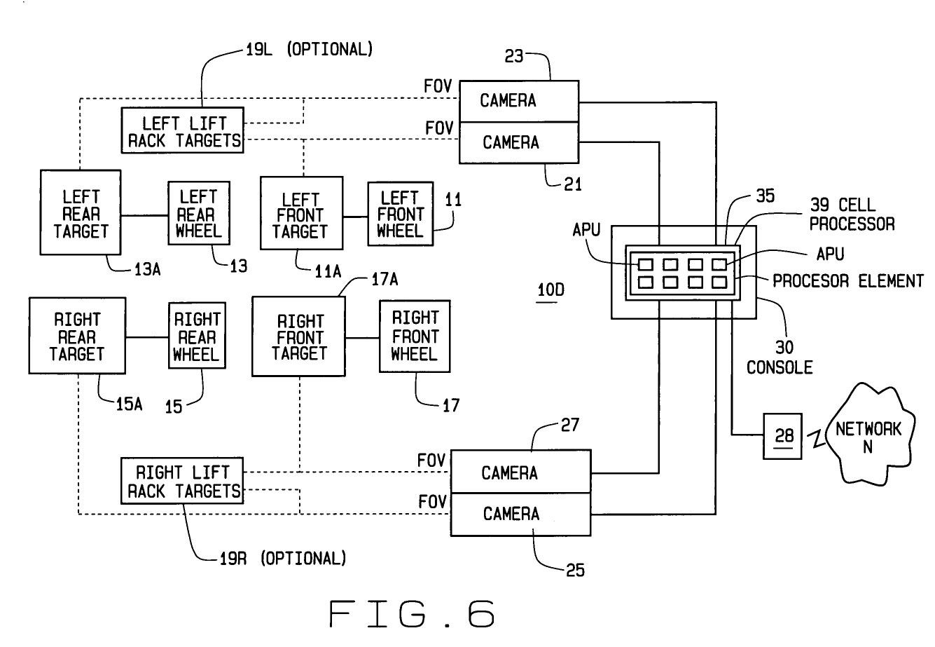

Turning to FIG. 6, an advanced computer processor architecture designed for specialized use in graphics-intensive gaming systems, supercomputers, and military applications is adapted for use in a vehicle service system 10D of the present invention to increase processing capability over traditional single-core processors. This advanced computer processor architecture is referred to in the industry as CELL processing, and utilizes a suite of processing units operating in parallel to execute specialized software applications. U.S. Pat. No. 6,809,734 to Suzuoki et al, herein incorporated by reference, describes a parallel-processing modular microprocessor architecture and associated programming model known in the industry as “CELL” for binding program code and data together in bundles suitable for distributed system execution over multiple processing units which may be interconnected locally by a data bus or remotely by a broadband network.

Preferably, the vehicle wheel alignment system 10D is configured with at least one CELL processor 39 having at least one processor element (PE) with at least one, and preferably eight, attached processing unit (APU), as described in the '734 Suzuoki et al. reference. The processor element and attached processing units are preferably formed on a common integrated circuit or chip, together with the interconnecting data bus and associated local memory stores from which the processing units process software application modules. A shared access main memory store is further provided, and access thereto is regulated by a synchronized system and method for the coordinated reading and writing of data to and from the shared memory by the processing units at a high bandwidth. The high bandwidth for data communications within a CELL processor may be up to 200 GB/S internally, and up to 76.8 GB/S externally through suitable communication interfaces.

Detailed disclosure related to CELL processors and the associated specialized software module requirements can be found in U.S. Pat. Nos. 6,826,662 and 6,526,491 to Suzuoki et al. and in U.S. Patent Application Publications Nos. 2002/0138637 A1, 2002/0156993 A1, and 2003/0229765 A1, each to Suzuoki et al., and each incorporated herein by reference.

Within a CELL processor 39, the processor element (PE) and each attached processing unit (APU) is the functional equivalent of a single processor core, hence the vehicle wheel alignment system 10F configured with the CELL processor 39 as a central processor functions in much the same manner as the vehicle service system 10A having the multi-core central processor 31. However, the unique architecture of a CELL processor 39 requires that traditional software applications utilized on the vehicle wheel alignment system 10D be adapted for modular execution on the CELL processor 39. Within the software applications, uniform software cells are defined which contain both data and applications which are structured for processing by any of the interconnected processing units linked to the CELL processor 39. Preferably, software cells which carry out repeated and similar procedures, such as rendering and modifying graphics are distributed to the processing units (APUs) with the CELL processor 39, while software cells which carry out unique or limited numbers of procedures are processed by the processor element (PE) which additionally oversees distribution of software cells to the processing units (APUs).

In an embodiment, the vehicle wheel alignment system 10D central processor is configured as a CELL processor 39 having a single processor element (PE) configured with eight attached processing units (APU), linked by a local communication bus. The local communication bus of the attached processing units APUs is linked to a global bus (not shown) which interfaces with a main memory store (not shown) and interconnected peripheral components such as the optical sensors 21, 23, 25, and 27.

The processing unit (PU) of the CELL processor 39 is configured to dispatch vehicle wheel alignment software cells to the local processing units (APUs), or via a broadband connection 28 to a network N, to remotely located CELL processor elements (PE) when the local CELL processing element (PE) lacks sufficient processing resources to handle the current workload. For example, during the computationally intensive task of extracting alignment information out of an image acquired by an optical sensor, the vehicle wheel alignment system 10D configured with the CELL processor 39 and coupled to the network N, may dispatch vehicle wheel alignment software cells (apulets) to CELL processor elements (PE) located in idle vehicle wheel alignment systems or other service systems coupled to the network N. The wheel alignment software cells (apulets) are processed by the remote CELL processor elements (PE), and returned to the vehicle wheel alignment system in a transparent manner, effectively distributing the processing load among available interconnected CELL processors elements (PE), as needed.

Those of ordinary skill in the art will recognize that the individual optical sensors utilized in a vehicle service system, such as a vehicle wheel alignment system, may incorporate CELL sensor processors and software cells configured for preprocessing image data acquired by the optical sensors before communicating the data to a central processor. The central processor itself may be a CELL processor, and any other suitable processor adapted to carry out the functions of the vehicle service system. Such a configuration is particularly advantageous for machine vision vehicle wheel alignment systems, and enable the CELL sensor processors to distribute image processing workloads in an efficient manner. For example, during vehicle wheel alignment procedures which only require images from the front vehicle wheels to be processed, CELL sensor processors associated with rear-imaging optical sensors in the service system may be utilized to carry out a portion of the image preprocessing required for images acquired by the front-imaging optical sensors. Alternatively, during periods of time when no images are currently being acquired by the optical sensors, the idle CELL sensor processors may be utilized to execute a distributed processing load from a central CELL processor in the vehicle service system.

Those of ordinary skill will recognize that vehicle wheel alignment software applications, and other vehicle service software applications, which are adapted for use on vehicle service devices incorporating CELL processor elements (PE) require discrete software cells (apulets) which are essentially self-contained blocks of data and instructions, and which are capable of seeking available processing resources for execution as required.

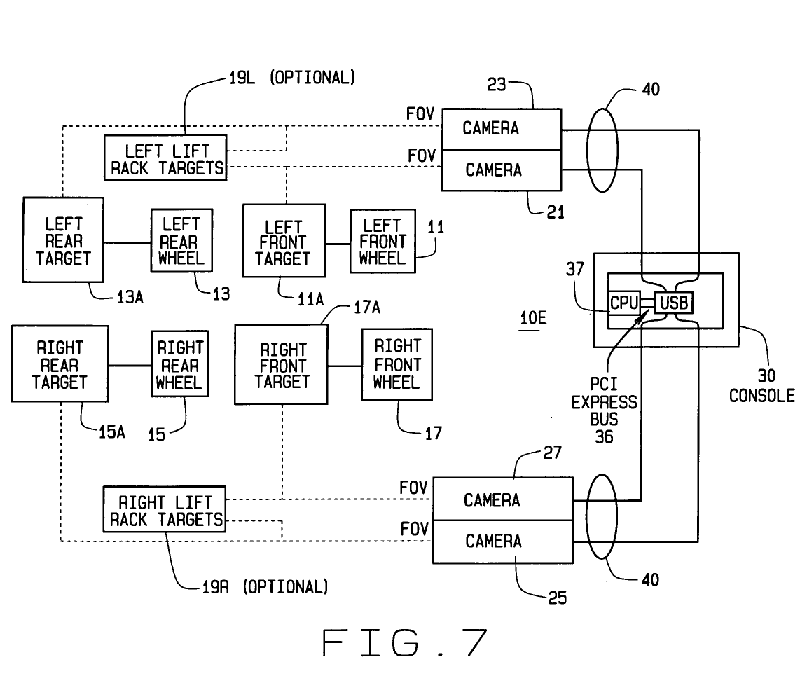

Whenever multiple functions are executed on a processor, such as a single-core or multi-core processor, data communication busses between peripheral components and the central processor can create a bottleneck to further increasing system performance. In an alternate embodiment of the present invention, a vehicle wheel alignment system 10F shown in FIG. 7 incorporates an improved communication bus architecture known as a PCI-Express bus 36 to facilitate data communication between peripheral components such as the optical sensors (cameras) 21, 23, 25, and 27 and the central processing unit 37.

The PCI-Express bus 36 provides a two way, serial connection between the central processor 37 and one or more peripheral components. The PCI-Express bus 36 is an assembly of serial, point-to-point wired, individually clocked ‘lanes’ each consisting of two pairs of data lines that carry data packets upstream and downstream, with a capacity theoretically reaching 2.5 Gb/s in each direction, and with an overall sustained transfer rate approximately equal to 200 MB/s for each lane.

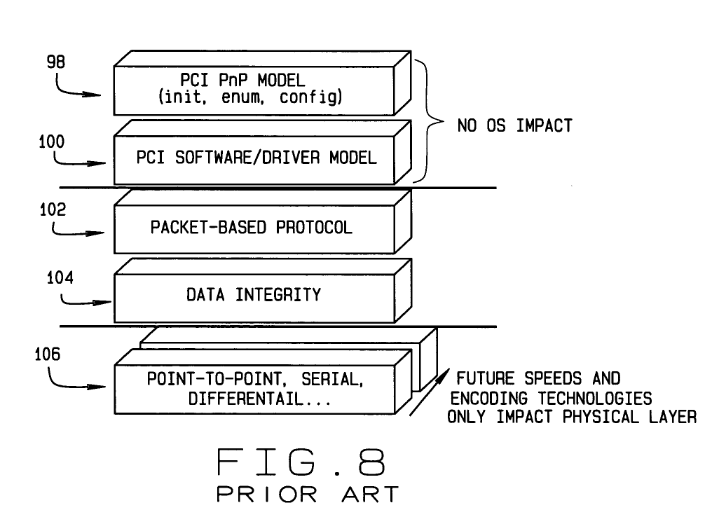

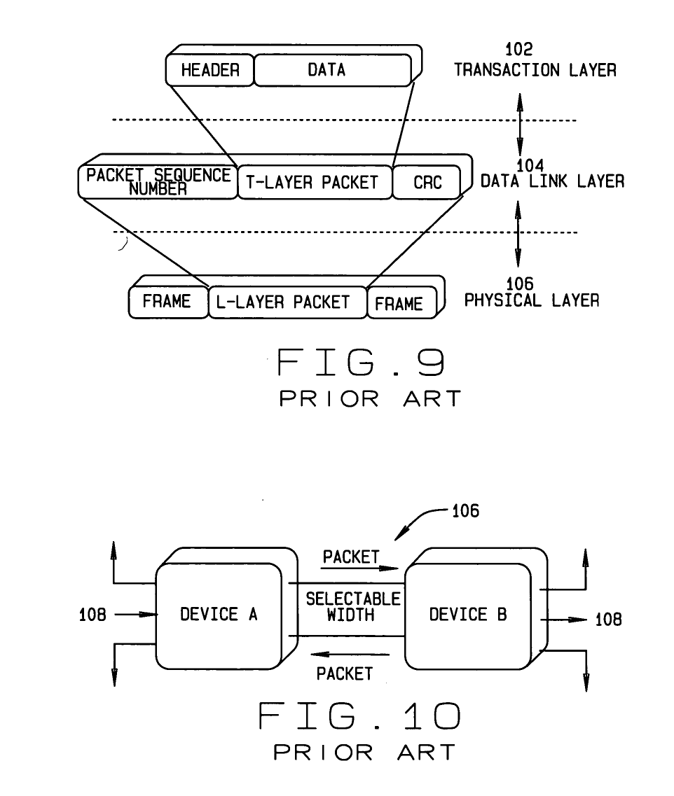

The PCI Express bus architecture incorporated into the vehicle wheel alignment system is specified in layers, as shown in FIG. 8. The PCI Express bus configuration uses a standard operating system configuration mechanism 98 to ensure compatibility over a wide range of peripheral components and software applications. A software layer 100 generates read and write requests that are transported by a transaction layer to the I/O devices using a packet-based, split-transaction protocol. A data link layer 104 adds sequence numbers and CRC to these packets to create a highly reliable data transfer mechanism. The primary role of a link layer is to ensure reliable delivery of the packet across the PCI Express link. The link layer is responsible for data integrity and adds a sequence number and a CRC to the transaction layer packet as shown in FIG. 9. The link layer is configured to automatically retry transmission of a corrupted packet.

A basic physical layer 106 consists of a dual simplex channel implemented as a transmit pair and a receive pair of low-voltage AC-coupled differential signals as shown in FIG. 10. The physical link signal uses a de-emphasis scheme to reduce inter-symbol interference, thus improving data integrity. A data clock signal 108 is embedded using an 8B/10B encoding scheme (each 8-bit byte is translated into a 10-bit character in order to equalize the numbers of 1's and 0's sent) to achieve very high data rates, with signaling frequency between 2.5 Gb/s/direction (Generation 1 signaling) and 10 Gb/s/direction (the practical maximum for signals in copper). The physical layer transports packets between the link layers of two PCI Express components.

Optionally, the bandwidth of the PCI Express bus 36 in the vehicle wheel alignment system 10D may be linearly scaled by adding additional physical layer 106 signal pairs to form multiple lanes. The physical layer 106 provides x1, x2, x4, x8, x12, x16 and x32 lane widths and splits the byte data. Each byte is transmitted, with 8B/10B encoding, across the lane(s). This data disassembly and reassembly is transparent to other layers.

During operation of the vehicle wheel alignment system 10E, most packets communicated over the PCI Express bus 36 are initiated at the transaction layer 102. A credit-based, flow control protocol ensures that the packets are transmitted only when it is known that a buffer is available to receive this packet at the other end, which eliminates any packet retries and the associated waste of bus bandwidth due to resource constraints. The transaction layer 102 receives read and write requests from the software layer 100 and creates request packets for transmission to the link layer 104. All requests are implemented as split transactions and some of the request packets require a response packet. The transaction layer 102 is further configured to receive response packets from the link layer 104 and to match these with the original software requests. Each packet communicated over the PCI Express bus 36 has a unique identifier that enables response packets to be directed to the correct originator. The packet format preferably offers 32-bit memory addressing and extended 64-bit memory addressing. Packets also have attributes such as “no-snoop,” “relaxed ordering” and “priority,” which may be used to route these packets optimally through the I/O subsystem of the CPU 37.

The transaction layer 102 preferably provides four address spaces—three PCI address spaces (memory, I/O, and configuration) and a Message Space. An alternate method of propagating system interrupts, called Message Signaled Interrupt (MSI), may be utilized to provide a special-format memory-write transaction instead of a hard-wired sideband signal. A vehicle wheel alignment system 10E configured with a PCI Express bus 36 may utilize MSI as a primary method for interrupt processing and may use the Message Space address space to accept all prior sideband signals, such as interrupts, power-management requests, and resets, as in-band Messages. Optionally, the vehicle wheel alignment system 10E may implement other “special cycles” within the PCI Express bus configuration, such as Interrupt Acknowledge, as in-band Messages.

A vehicle wheel alignment system 10E configured with the PCI Express bus architecture for data communication has the advantage of software compatibility with prior art communication bus configurations. There are two facets of software compatibility—initialization (or enumeration) and run time. Existing communication bus protocols, such as standard PCI, have a robust initialization model which enables an operating system to discover all of the add-in hardware devices present in a system, and to then allocate system resources, such as memory, I/O space and interrupts, to create an optimal system environment. The PCI configuration space and the programmability of I/O devices are key concepts that remain unchanged within the PCI Express bus architecture. Existing vehicle wheel alignment system CPU operating systems are able to boot without modification on a PCI Express-based vehicle wheel alignment system 10E of the present invention. The run-time software model used by PCI is a load-store, shared memory model, which is maintained within the PCI Express bus architecture to enable all existing vehicle wheel alignment processing software and image processing software to execute unchanged.

Optionally, the vehicle wheel alignment system 10E may be configured to include one or more connectors configured to permit external devices to be connected directly to the PCI Express bus 36 communications pathways. An exemplary connector suitable for connection to the PCI Express bus communication pathway conforms to the PCI ExpressCard specification, and provides the physical hardware requirements to replace conventional parallel buses for I/O devices with two scalable, high-speed serial interfaces, PCI Express and USB 2.0. A PCI ExpressCard provides PCI Express bus connectivity for high performance applications, and USB connectivity to remain compatible with the wide variety of USB-based peripheral devices currently available.

Each PCI ExpressCard connector includes at least a single PCI Express lane operating at the baseline 2.5 Gb/s data rate, in each direction. The ExpressCard host interface further accepts the low, full, and high-speed USB data rates as defined by the USB 2.0 Specification. The PCI ExpressCard connector can use one or both of the standard interfaces depending on the application requirements. Depending upon the particular requirements of the devices connected to the PCI Express bus 36, the connector may be modified as required to provide features such as closed chassis adapter removal/insertion, integrated hot-plug, adapter protection from ESD and handling damage, standardized management interfaces and features, adequate cooling, single bulk power supply, and reduced I/O footprints.

In the embodiment of the vehicle wheel alignment system 10E, shown in FIG. 7, configured with the PCI Express bus communications pathway 36, the signals from the optical sensors 21, 23, 25, and 27 are supplied to the wheel alignment system console 30 via a Universal Serial Bus (USB) 40. Alterative communication means may be utilized to couple the optical sensors 21, 23, 25, and 27 to the computer, such as Firewire 1394, CameraLink, or other suitable data links. Within the computer 37, the USB bus is operatively coupled to the processing core via the PCI Express bus 36. The vehicle wheel alignment system computer 37 is further configured with one or more vehicle wheel alignment software applications adapted to utilize the acquired image data signals to determine various wheel alignment angles as is known in the art.

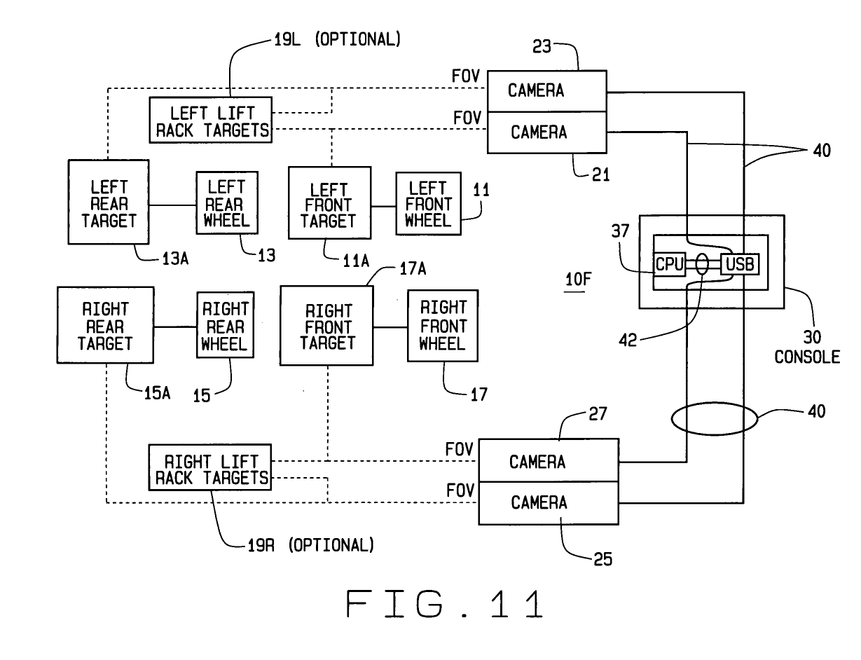

In an alternate embodiment vehicle wheel alignment system 10F of the present invention, shown in FIG. 11, the signals from the optical sensors 21, 23, 25, and 27 are supplied to the wheel alignment system console 30 via a USB communication bus 40 operatively coupled to a computer 37 disposed within the console 30. Within the computer 37, the USB bus 40 is operatively coupled to the central processing processor 37 via an improved video bus 42. The central processing unit 37 is configured with vehicle wheel alignment software adapted to utilize the acquired image data signals to determine various wheel alignment angles using known image processing algorithms. The improved video bus 42 preferably consists of an assembly of serial, point-to-point wired, individually clocked data pathways. Each data pathway further consists of two pairs of data lines for carrying bidirectional data.

Those of ordinary skill in the art will recognize that one or more of the various alternate embodiments of the vehicle wheel alignment system 10A-10F of the present invention may be combined in a single machine vision vehicle wheel alignment system to provide improved wheel alignment and image processing capacity. For example, a machine vision vehicle wheel alignment system variation of the present invention may include a multi-cored CPU 31 linked to individual optical sensors 21, 23, 25, and 27 by a PCI Express bus 37. Similarly, a machine vision vehicle wheel alignment system variation of the present invention may include a multi-cored CPU 31 configured with Hyper-Threading technology to include multiple logical processors, and which is linked to individual optical sensors 21, 23, 25, and 27 by an improved video bus, as well as to one or more additional peripheral components by a PCI Express bus 37.

Those of ordinary skill in the art will readily recognize that the increased processing capacity in vehicle wheel alignment systems provided by the use of multi-core processors, CELL processors, Hyper-Thread enabled processors, and improved communication bus technologies will facilitate a wide variety of improved vehicle wheel alignment procedures, and enable the acquisition and processing of images at significantly greater rates than have been previously achieved using current machine vision vehicle wheel alignment systems.

The improved image processing features of the present invention are not limited to use in machine-vision vehicle wheel alignment systems, but may be utilized in any vehicle service system utilizing machine vision. For example, a vehicle wheel balancing system may be configured with a multi-core processor and/or communication bus described herein and operatively coupled to at least one imaging sensor for acquiring image data, from which information such as vehicle wheel runout measurements or unloaded tire runout measurements can be acquired.

Alternatively, a vehicle tire changing system may be configured with a multi-core processor and/or communication bus described herein and operatively coupled to at least one imaging sensor for acquiring image data, from which information such as vehicle wheel runout measurements or unloaded tire runout measurements can be acquired.

Alternatively, a vehicle brake service system may be configured with a multi-core processor and/or communication bus described herein and operatively coupled to at least one imaging sensor for acquiring image data, from which information such as brake rotor runout measurements, wheel axis of rotation identification, rotor flatness measurements, and hot-spot identification can be acquired.

The present invention can be embodied in-part in the form of computer-implemented processes and apparatuses for practicing those processes. The present invention can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved machine-vision vehicle service system having a central processor operatively coupled to at least one optical sensor to receive acquired image data there from, the improvement wherein:
said central processor includes at least two processor cores to define a multi-core processor adapted for concurrent execution of a plurality of vehicle service software instructions.

2. The improved machine vision service system of claim 1 wherein said central processor is configured with at least one vehicle service software application adapted for multi-threaded execution on a multi-core processor.

3. The improved machine vision vehicle service system of claim 1 wherein said central processor is configured with at least one multi-threaded vehicle service software application selected from a set of software applications including a vehicle wheel alignment software application, a vehicle wheel balancing software application, a vehicle tire changing software application, and a vehicle brake rotor service software application.

4. The improved machine vision vehicle service system of claim 1 wherein each processor core in said multi-core processor is configured for concurrent execution of a vehicle service software instruction thread.

5. The improved machine vision vehicle service system of claim 1 wherein each processor core in said multi-core processor is configured for Hyper-Threading execution of software instructions.

6. The improved machine vision vehicle service system of claim 1 wherein said central processor is operatively coupled to said at least one optical sensor via a communications pathway to receive acquired image data there from; and
wherein at least a portion of said communication pathway defines at least one pair of individually clocked, point-to-point data lines, each of said pair of data lines configured to provide two-way serial transport of data packets.

7. An improved machine vision vehicle wheel alignment system having a single-core central processor operatively coupled to at least one optical sensor to receive acquired image data there from, the improvement wherein:
said single-core central processor is configured for concurrent execution of at least two vehicle service software instruction threads.

8. The improved machine vision vehicle wheel alignment system of claim 7 wherein said single-core central processor is configured with at least one vehicle service software application adapted for Hyper-Threading instruction execution, said software application selected from a set of software applications including a vehicle wheel alignment software application, a vehicle wheel balancing software application, a vehicle tire changing software application, and a vehicle brake rotor service software application.

9. The improved machine vision vehicle wheel alignment system of claim 7 wherein said single-core central processor has a Virtualization Technology configuration.

10. The improved machine vision vehicle service system of claim 7 wherein said single-core central processor is operatively coupled to said at least one optical sensor via a communications pathway to receive acquired image data there from; and
wherein at least a portion of said communication pathway defines at least one pair of individually clocked, point-to-point data lines, each of said pair of data lines configured to provide two-way serial transport of data packets.

11. An improved machine-vision vehicle service system having a central processor configured with at least one vehicle service software application and operatively coupled to at least one optical sensor via a communications pathway to receive acquired image data there from, the improvement wherein:
at least a portion of said communication pathway defines at least one pair of individually clocked, point-to-point data lines, each of said pair of data lines configured to provide two-way serial transport of data packets.

12. The improved machine-vision vehicle service system of claim 11 wherein said portion of said communication pathway defines a plurality of pairs of individually clocked, point-to-point data lines, each of said pair of data lines configured to provide two-way serial transport of data packets.

13. The improved machine-vision vehicle service system of claim 11 wherein said portion of said communication pathway defines at least one PCI Express bus configured to provide two-way serial communication between at least one peripheral component and said central processor.

14. The improved machine-vision vehicle service system of claim 13 wherein said central processor is operatively coupled to said at least one optical sensor via said at least one PCI Express bus.

15. The improved machine vision vehicle service system of claim 11 wherein at least one vehicle service software application is selected from a set of software applications including a vehicle wheel alignment software application, a vehicle wheel balancing software application, a vehicle tire changing software application, and a vehicle brake rotor service software application.

16. An improved machine-vision vehicle service system having a central processor operatively coupled to at least one optical sensor to receive acquired image data there from, the improvement wherein:
said central processor is configured with a parallel-processing modular architecture and associated programming model to function as at least one CELL processor, including at least one CELL processing element and at least one attached processing unit; and
wherein each attached processing unit is configured to execute a software cell.

17. The improved machine-vision vehicle service system of claim 16 wherein each of said software cells is adapted for execution on a CELL processor.

18. The improved machine-vision vehicle service system of claim 16 wherein said central processor is configured to include at least eight attached processing units, each of said attached processing units linked via a local communication bus.

19. The improved machine-vision vehicle service system of claim 16 wherein said at least one CELL processing element is operatively connected to at least one remote CELL processor via a communications network; and
wherein said at least one CELL processing element is configured to dispatch at least one vehicle service software cell to said at least one remote CELL processor via said communications network.

20. The improved machine vision vehicle service system of claim 16 wherein said central processor is configured with at least one vehicle service software application configured with a plurality of self-contained software cells adapted for concurrent execution on a multi-core processor, said software application selected from a set of software applications including a vehicle wheel alignment software application, a vehicle wheel balancing software application, a vehicle tire changing software application, and a vehicle brake rotor service software application.

21. The improved machine vision vehicle service system of claim 20 wherein each of said self-contained software cells includes program code and data.

22. The improved machine vision vehicle service system of claim 16 wherein the at least one optical sensor is configured for image processing with a sensor processor having a parallel-processing modular architecture and associated programming model to function as at least one CELL processor, including at least one CELL processing element and at least one attached processing unit; and
wherein each attached processing unit is configured to execute a software cell.

23. The improved machine vision vehicle service system of claim 22 wherein said at least one CELL processing element of said sensor processor is operatively connected to said CELL processor of said central processor via a communications pathway; and
wherein said at least one CELL processing element of said sensor processor is configured to exchange software cells with said at least one CELL processor of said central processor via said communications pathway.

24. The improved machine vision vehicle service system of claim 16 wherein each optical sensor coupled to the central processor is configured with a sensor processor having a parallel-processing modular architecture and associated programming model to function as at least one CELL sensor processor, including at least one CELL processing element and at least one attached processing unit.

25. The improved machine vision vehicle service system of claim 24 wherein each optical sensor is further configured with an image processing application adapted for execution on said at least one CELL sensor processor to process image data acquired by the optical sensor.
